(19) United States
(12) Patent Application Publication
(10) Pub. No.: US 2025/0358127 A1
(43) Pub. Date: Nov. 20, 2025

(54) PRIVACY SENSITIVE, DECENTRALIZED PROCESS FOR RESTRICTED DISTRIBUTION AND ATTRIBUTION OF DATA DISTRIBUTION

(71) Applicant: QUALCOMM Incorporated, San Diego, CA (US)

(72) Inventors: Ashok BHATIA, San Diego, CA (US); Richard SENIOR, San Diego, CA (US)

(21) Appl. No.: 18/664,238

(22) Filed: May 14, 2024

(51) Int. Cl. H04L 9/32; H04L 9/08

(52) U.S. Cl. CPC H04L 9/3236; H04L 9/0825; H04L 9/3247

(57) ABSTRACT

Systems and techniques are provided for image processing. For instance, a process can include receiving an asset for distribution to a first entity, header information associated with the asset, and identity information for the first entity; applying a hashing function to the header information to generate hashed header information; generating an asset block based on the hashed header information, the identity information, and the asset; signing the generated asset block to generate a signed asset block; applying the hashing function to the signed asset block to generate a hash of the asset block; transmitting the hash of the asset block to an asset repository server; and outputting the signed asset block for distribution to the first entity.

### FIELD

The present application is related to restricted distribution and attribution of data. For example, aspects of the present application relate to systems and techniques for a privacy sensitive, decentralized process for restricted distribution and attribution of data distribution.

### BACKGROUND

Certain documents and/or data may be considered restricted (e.g., protected, confidential, etc.) and access to those documents or data may be limited to a certain group. For example, organizations may want to restrict access to documents including sensitive business information, technical information, etc. or data, such as log files, debugging files, etc. Typically, such sensitive files may be managed by a central repository or server with access permissions and/or an access control list of groups or users that may access the files. When a file is accessed by a user with valid credentials, some repository systems may provide a watermarked (e.g., digital watermark) version of the file that may be used to identify the user that accessed the file. This watermark may provide a way to attribute (e.g., attribution) the user that accessed the file in case the file ends up being distributed in an unauthorized way. Such centralized repository systems can make sharing files among authorized users difficult, especially when such authorized users are with a separate organization. Additionally, such centralized repository systems may raise concerns about privacy and/or storage of personally identifiable information (PII) of members of the separate organization. In some cases, techniques for a privacy sensitive, decentralized process for restricted distribution and attribution of data distribution may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems and techniques for providing a privacy sensitive, decentralized process for restricted distribution and attribution of data distribution. In one illustrative example, an apparatus for digital asset distribution is provided. The apparatus includes at least one memory; and at least one processor coupled to the at least one memory. The at least one processor is configured to: receive an asset for distribution to a first entity, header information associated with the asset, and identity information for the first entity; apply a hashing function to the header information to generate hashed header information; generate an asset block based on the hashed header information, the identity information, and the asset; sign the generated asset block to generate a signed asset block; apply the hashing function to the signed asset block to generate a hash of the asset block; transmit the hash of the asset block to an asset repository server; and output the signed asset block for distribution to the first entity.

As another example, a method for digital asset distribution is provided. The method includes: receiving an asset for distribution to a first entity, header information associated with the asset, and identity information for the first entity; applying a hashing function to the header information to generate hashed header information; generating an asset block based on the hashed header information, the identity information, and the asset; signing the generated asset block to generate a signed asset block; applying the hashing function to the signed asset block to generate a hash of the asset block; transmitting the hash of the asset block to an asset repository server; and outputting the signed asset block for distribution to the first entity.

In another example, a non-transitory computer-readable medium having stored thereon instructions is provided. The instructions, when executed by at least one processor, cause the at least one processor to: receive an asset for distribution to a first entity, header information associated with the asset, and identity information for the first entity; apply a hashing function to the header information to generate hashed header information; generate an asset block based on the hashed header information, the identity information, and the asset; sign the generated asset block to generate a signed asset block; apply the hashing function to the signed asset block to generate a hash of the asset block; transmit the hash of the asset block to an asset repository server; and output the signed asset block for distribution to the first entity.

As another example, an apparatus for digital asset distribution is provided. The apparatus includes: means for receiving an asset for distribution to a first entity, header information associated with the asset, and identity information for the first entity; means for applying a hashing function to the header information to generate hashed header information; means for generating an asset block based on the hashed header information, the identity information, and the asset; means for signing the generated asset block to generate a signed asset block; means for applying the hashing function to the signed asset block to generate a hash of the asset block; means for transmitting the hash of the asset block to an asset repository server; and means for outputting the signed asset block for distribution to the first entity.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an example of a network that techniques for a privacy sensitive, decentralized process for restricted distribution and attribution of data distribution may operate across, in accordance with aspects of the present disclosure;

FIG. 2 is a diagram illustrating a technique for a privacy sensitive, decentralized process for restricted distribution and attribution of data distribution, in accordance with aspects of the present disclosure;

FIG. 3 is a diagram illustrating data transfers for a privacy sensitive, decentralized process for restricted distribution and attribution of data distribution, in accordance with aspects of the present disclosure;

FIG. 4 is a diagram illustrating data transfers for a privacy sensitive, decentralized process for restricted distribution and attribution of data distribution, in accordance with aspects of the present disclosure;

FIG. 5 is a flow diagram illustrating a process for asset distribution, in accordance with aspects of the present disclosure; and

FIG. 6 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In a traditional asset (e.g., content) management system, assets (e.g., documents, data, files, etc.) may be managed by a central repository for a first organization (e.g., company, group, original equipment manufacturer (OEM) etc.). The assets may be digital assets which are any digital content for which access should be restricted. Users of the asset management system may have certain access permissions and the users may be arranged in groups having similar access permissions. To access an asset in the asset management system, a user may provide their credentials and these credentials may be verified by the asset management system. In some cases, assets provided to the user may be watermarked with an identity of the user which accessed the asset. This watermark may provide attribution in case the asset winds up with an unauthorized person/party as the asset includes information indicating which user originally accessed the asset from the asset management system. In some cases, the attribution capability may provide a sufficient deterrent to avoid distribution of the asset to unauthorized persons/parties.

In some cases, the users may include members of the first organization (e.g., employees) or members of another organization (e.g., contractors, employees of a partner company, etc.). For example, a first organization may partner with multiple other organization to produce products. These products may generate log files (e.g., assets) that may be stored in an asset management system. As these log files may include trade secrets, access to the log files may be restricted to include specific organizations. As the asset management system may be provided by the first organization, members of another organization that wants to access the asset management system may have to provide identifying information to the asset management system. However, other organizations may be reluctant to provide identifying information about their members. Additionally, a single identity for the other organization may not provide sufficient granularity and/or security. Further, members of the first organization may be reluctant to provide the asset to other persons/organizations, even if the other Polsinelli Ref. No. 094922-789038 person/organization should be able to access the asset, as the asset may still be attributable to the members of the first organization. In some cases, it may be useful to centrally manage digital content while allowing the digital content (e.g., asset) to be distributed to different parties in a distributed fashion while still maintaining an audit trail.

Data attribution may refer to an ability to determine how digital asset/media is transmitted from one entity to another. Attribution of data to certain entities and establishing a chain of attribution indicating how the digital asset/media was transmitted (e.g., from a certain image capturing device to a certain video processing software, and then to a certain social media website, etc.) may be useful to establish a provenance of a digital asset or determine how a digital asset was obtained.

Systems, apparatuses, electronic devices, methods (also referred to as processes), and computer-readable media (collectively referred to herein as “systems and techniques”) are described herein for a privacy sensitive, decentralized process for restricted distribution and attribution of data. For example, assets may be stored in a server, such as an asset repository server. Assets may be distributed from the asset repository server to an authenticated user via a distribution tool. To access an asset, the authenticated user may provide their identity to the asset repository server and the asset repository server may provide the identity of the authenticated user, the asset, and header information associated with the asset to the distribution tool. The distribution tool may hash the header information (e.g., by applying a hashing function or algorithm to the header information, such as a secure hashing algorithm (SHA)-256 or SHA-512) and combine the hashed header information with additional information, such as an identifier for the asset repository server and/or nonce number as a header for a first asset block. The first asset block may also include the identity information and the asset. The first asset block may be signed and hashed (e.g., by applying the hashing function or algorithm to the first asset block). The hash of the first asset block (e.g., asset block hash) may be stored by the asset repository server and the first asset block may be distributed to the authenticated party.

In some cases, the authenticated party may redistribute the received first asset block using the distribution tool. In some cases, to generate a second asset block for redistribution the authenticated party may obtain identifying information for a trusted party. The authenticated party may input, to the distribution tool, the identifying information for the trusted party and the asset (e.g., first asset block (including header) received from the asset repository server). The distribution tool may generate a second asset block in a manner similar to that discussed above with respect to the authenticated party. As indicated above, the distribution tool may generate a hash of the second asset block (e.g., by applying the hashing function or algorithm to the second asset block). The hash of the second asset block (and possibly hash of the first asset block) may be passed to the asset repository server. As the asset repository server receives the hash of the second asset block, the identity of the trusted party is concealed from the asset repository server. The identity of the trusted party is embedded in the second asset block and should the second asset block be redistributed in an unauthorized manner, the identity information may be extracted from the redistributed second access block for attribution purposes. The hash of the second asset block may help allow a distribution tool to verify an asset block.

Various aspects of the application will be described with respect to the figures.

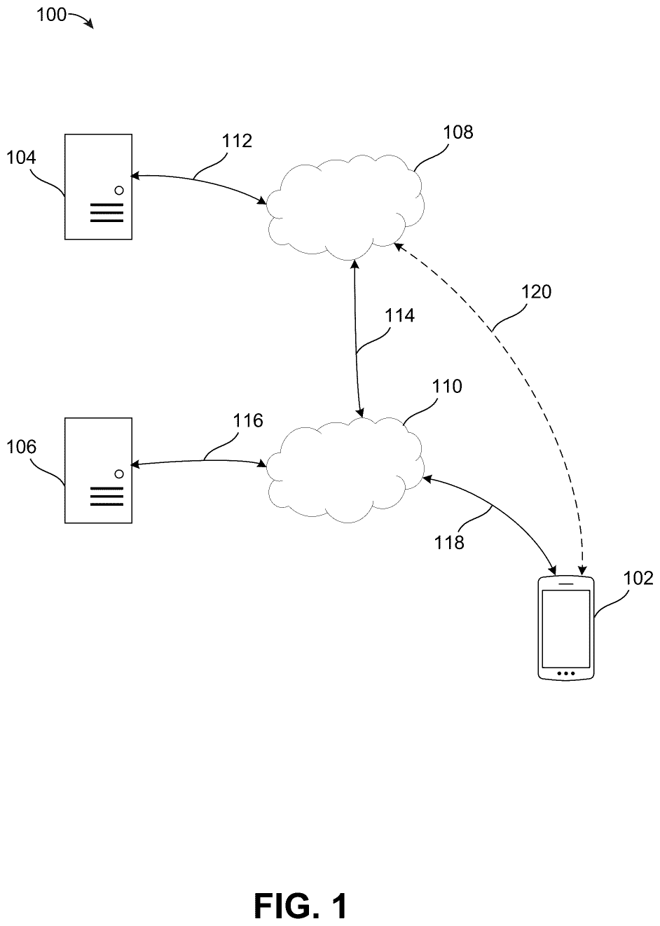

FIG. 1 illustrates an example of a network 100 that techniques for a privacy sensitive, decentralized process for restricted distribution and attribution of data distribution may operate across, in accordance with aspects of the present disclosure. The network 100 includes a device 102, a wide area server 104, and a local area server 106. The wide area server 104 is coupled to a wide area network 108 (e.g., the internet) via the link 112. The wide area server 104 may also be coupled to the device 102 via link 120. The wide area network 108 is further coupled to a local area network 110 via the link 114. The local area network 110 is coupled to the local area server 106 via the link 116 and is also coupled to the device 102 via the link 118.

The wide area network 108 may include any combination of wired and/or wireless networks that allows content to be delivered over a wide area. For example, the wide area network 108 may deliver content to a county or state, multiple states, or an entire country. The communication links 112 and 114 comprise any suitable communication links, such as wired and/or wireless links, that operate to allow content (e.g., files, data streams, documents, etc.) to be transmitted from the server 104 to the network 108 and the network 110.

The local area network 110 comprises any combination of wired and/or wireless networks that allows content to be delivered over a local area. For example, the local area network 110 may deliver content to a house, company, neighborhood, city, or county. The local area server 106 communicates with the local area network 110 via the link 116. The link 116 comprises any suitable type of wired or wireless link that allows content to be transmitted from the local area server 106 over the local area network 110.

The device 102 may be a mobile device that communicates with the local area network 110 via the link 118. The device 02 may also communicate with the wide area network 108 via link 120. It should be noted that other devices are possible within the scope of the embodiments. For example, other devices suitable for use in one or more embodiments of the content insertion system comprise a personal digital assistant (PDA), email device, pager, a notebook computer, wired device, desktop computer, workstation, etc. The device 102 may access (e.g., download, stream, render, display, etc.) content received from the servers 104, 106. For example, the device 102 may receive one or more content streams (or channels) for rendering on the device 102. As another example, the device 102 may receive documents or other files that may be accessed by the device 102.

In some cases, the servers 104, 106 operate to deliver content to device 102. For example, the servers 104, 106 may store documents, files, or other content (e.g., data streams, logs, etc.) and operates to deliver this content to the device 102 across the wide area network 108 or local area network 110. The server 104 and server 106 may be the same device or separate devices. The wide area server 104 may deliver content via the wide area network 108 to the device 102 via any of links 120, 114, or 118. The local area server 106 may deliver content via the local area network 110 and link 118.

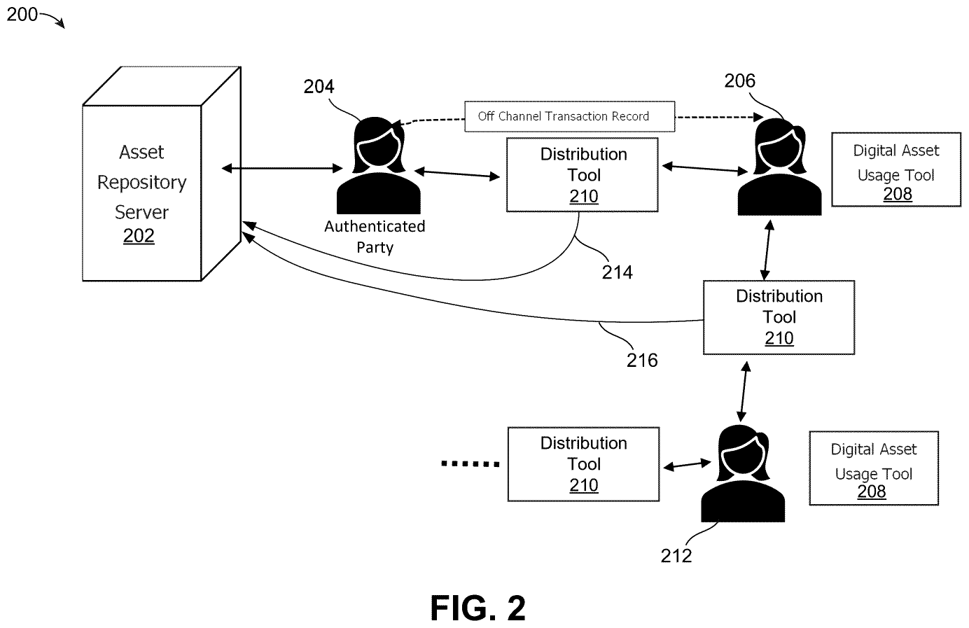

FIG. 2 is a diagram illustrating a technique 200 for a privacy sensitive, decentralized process for restricted distribution and attribution of data, in accordance with aspects of the present disclosure. In FIG. 2, an asset repository server 202 may store assets that may be accessed by authenticated users (e.g., authenticated parties), such as an authenticated party 204. An asset repository may be a secured storage where digital assets are stored. In some cases, authenticated users are allowed to obtain a copy of an asset from the asset repository server 202. In some cases, an identity of a user attempting to access the asset may be obtained. The identity of the user may be any identifier that can be used to identify a user, such as an email address, name, employee number, etc. In some cases, the asset repository server may maintain a whitelist of users allowed access to an asset. When the identity of a user attempting to access an asset has been provided and is authenticated, the user may become an authenticated party 204.

In some cases, the asset may be provided by the asset repository server 202 as an asset block (e.g., first asset block). The asset block may be a signed block of digital data that includes a public key of a signer (e.g., of an organization that controls the asset repository server 202) may be embedded in the asset block. The asset block may also include the asset wrapped with identity information metadata. As the asset block is signed, the asset block may not be modified without invalidating the signature.

In some cases, it may be useful for the authenticated party 204 to distribute an asset to a first trusted party 206 (e.g., entity). A trusted party may be any person or device that should have access to the digital asset. However, the trusted party may not be able to (e.g., cannot, is blocked from, will not, etc.) provide their identity and/or credentials to the asset repository server 202. The trusted party, such as the first trusted party 206, may have a relationship with the authenticated party 204 such that the authenticated party 204 trusts (e.g., has knowledge and/or belief that the trusted party should have access to the asset). For example, the first trusted party 206 may be an employee of an OEM partner working with the authenticated party 204 on a project attempting to access log files (e.g., assets) stored on the asset repository server 202.

To provide access to the asset, the first trusted party 206 may provide their identity to the authenticated party 204. For example, the first trusted party 206 may provide their email address to the authenticated party 204. The authenticated party 204 may use a distribution tool 210 to generate a second asset block for the first trusted party 206. The distribution tool 210 may generate the second asset block for the first trusted party 206 using a first asset block of the authenticated party 204 (e.g., obtained by the authenticated party 204 from the asset repository server 202) along with the identify information provided by the first trusted party 206 to the authenticated party 204. The identity information provided by the first trusted party 206 to the authenticated party 204 may be embedded within the second asset block. The distribution tool 210 may also generate a hash of the second asset block (e.g., by applying the hashing function or algorithm to the second asset block, such as SHA-256 or SHA-512) and transmit 214 the hash to the asset repository server 202. The hash may cover (e.g., the hash may be calculated using data from) the digital asset portion of an asset block, or the hash may cover other portions of the asset block in addition to the digital asset. The asset repository server 202 may maintain a chain of hashes based on how the asset may be distributed. In some cases, the distribution tool 210 may execute on a device of the authenticated party 204. In some cases, the distribution tool 210 may execute on a server, such as the asset repository server 202 or other server, for example, as a web application. After the second asset block is generated, the authenticated party 204 may then provide the second asset block to the first trusted party 206 through any technique, such as via an email attachment. In some cases, the authenticated party 204 and/or first trusted party may retain a record that the second asset block was provided to the first trusted party, such as a saved email record, as an off channel transaction record 218.

In some cases, restrictions may be added to asset block. For example, access restrictions such as when an asset block may be accessed (e.g., dates within which the asset block may be accessed), from which computer (e.g., via IP address/MAC address, etc.) can access the asset block, etc. may be added, for example, by the distribution tool 201. These restrictions may be included in the asset block. In some cases, the first trusted party 206 may access the asset block using the digital asset usage tool 208 and the digital asset usage tool 208 may enforce the restrictions.

In some cases, the asset within the asset block may be encrypted and/or otherwise secured. The asset may be accessible via a digital asset usage tool 208. In some cases, the digital asset tool 208 may hash the asset block (e.g., by applying the hashing function or algorithm to the asset block) received by the digital asset usage tool 208 and the digital asset usage tool 208 may verify with the asset repository server 202 whether there is a record of the hash of the asset block at the asset repository server 202. If there is a record of the hash (e.g., in a chain of hashes), then the digital asset repository server 202 may permit access to the asset, for example by transmitting an indication that the asset block may be accessed to the digital asset usage tool 208. If there is not a record of the hash, then the digital asset repository server may deny access to the asset, for example by transmitting an indication that the asset block may not be accessed to the digital asset usage tool 208 to cause the digital asset usage tool 208 to deny access to the asset. The digital asset usage tool 208 may also verify the digital signature of the asset block and allow access to the asset after verification of the digital signature.

In some cases, the first trusted party 206 may pass the asset to a second trusted party 212 in a manner similar to how the second asset block was provided to the first trusted party 206. For example, the first trusted party 206 may obtain identity information for the second trusted party 212. The identity information obtained from the second trusted party 212 may be similar to the identity information obtained from the first trusted party 206, or additional identity information may be provided. The identity information obtained from the second trusted party 212 may be input to the distribution tool 210 along with the second asset block to generate a third asset block. The distribution tool 210 may generate a first hash of the second asset block and a second hash of the third asset block and transmit 216 the hashes to the asset repository server 202 to allow the asset repository server to maintain a chain of hashes. Information associated with the identity information obtained from the first trusted party 206 and identity information obtained from the second trusted party 212 may embedded in the third asset block, but may not be transmitted along with the hashes. In some cases, the chain of hashes may be used to decentralize and protect the identity of the users (e.g., trusted users) from the organization associated with the digital asset repository server 202.

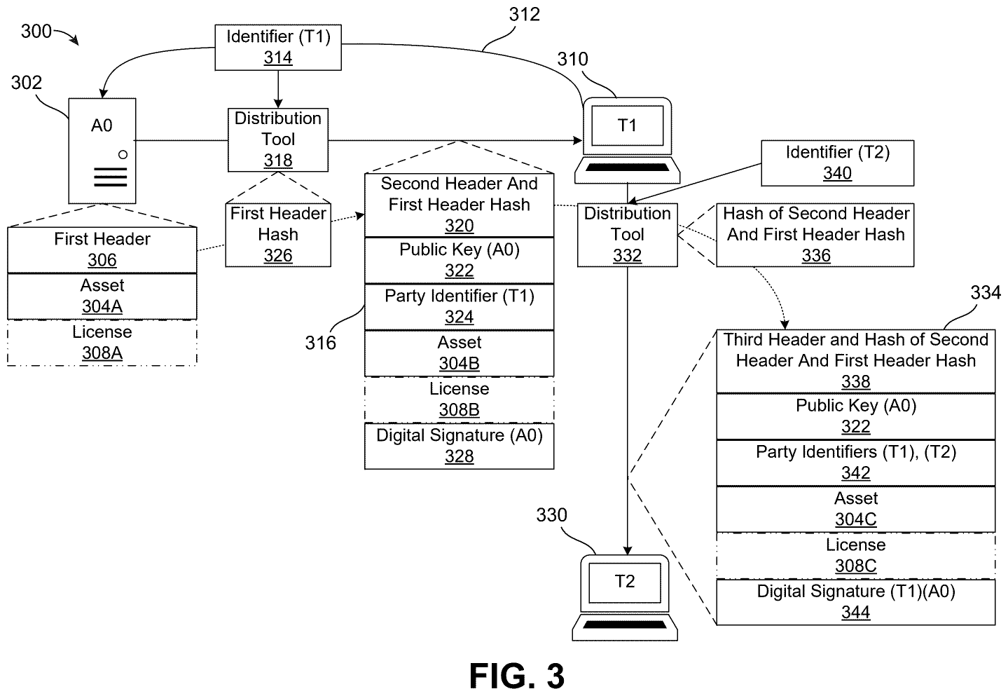

FIG. 3 is a diagram illustrating data transfers for a privacy sensitive, decentralized process for restricted distribution and attribution of data distribution 300, in accordance with aspects of the present disclosure. In FIG. 3, an asset repository server (A0) 302 may store one or more assets, such as asset 304. The asset repository server 302 may also store (or generate) information associated with the asset 304A, such as first header information 306 and optionally, a license 308A (collectively, license 308). The first header information 306 may include assert repository server information. For example, the asset repository server 302 may be associated with an identifier and that identifier, or a hash of the identifier, may be included in the first header information 306. The header may also include a nonce number (e.g., random number, semi-random number, pseudo-random number, etc.) and/or a timestamp (e.g., timestamp based on a request to access the asset 304A, when the asset was added to the asset repository server 302, etc.). The license 308 may include information indicating an identifier for the license 308, identify information about the distributor (e.g., the asset repository server 302, organization that operates the asset repository server 302, etc.), access restrictions for the asset, redistribution information (e.g., restrictions as to whether and to whom the asset 304A may be redistributed to), time limits, regional limits, and the like. In some cases, the first header information 306 and/or license 308A may be generated upon access to the asset and the first header information 306 and/or license 308A may be generated based on, for example, an identity of an authenticated party 310, when the access request is received, etc.

In some cases, to access the asset 304A, the authenticated party 310 (e.g., authenticated party) may provide 312 their identifier 314 to the asset repository server 302. The asset repository server 302 may generate a first asset block 316 for the authenticated party 310 using a distribution tool 318. The distribution tool 318 may generate a second header 320, which may include a hash 326 of the first header information. The second header 320 may also include other information, such as a timestamp (e.g., timestamp based on a request to access the asset 304A, when the second header 320 was generated, etc.) and/or another nonce number. In some cases, a public key 322 of the distributor (e.g., asset repository server 302) and a party identifier 324 (e.g., based on the identifier 314 of the authenticated party 310) may also be included in the first asset block 316 along with the asset 304B and license 308B.

In some cases, the party identifier 324 includes identifying information for the party (e.g., authenticated party 310) accessing the asset 304A. In some cases, the asset 304A may be modified by the distribution tool 318 to generate the asset 304B for the first asset block 316. For example, the asset 304A may be modified to include hidden and/or invisible watermarks in the asset. As another example, the asset 304A may be password protected and/or encrypted. The distribution tool 318 may modify the license 308A to generate license 308B included in the first asset block 316. For example, the license 308A may include a set of access restrictions that may be applied to the asset 304A and the distribution tool 318 may include a subset of the restrictions in license 308B based on a number of license factors, such as the identity of the authenticated party 310, options selected by the authenticated party 310, etc. The distribution tool 318 may also generate a first digital signature 328 for the first asset block to generate a signed asset block (e.g., asset block with a digital signature). The first digital signature 328 may be generated based on a private key of the distributor (e.g., asset repository server 302) and may include a hash of the asset block 316.

In some cases, such as where the license 308B allows the authenticated party 310 to redistribute the asset 304B, the distribution tool 318 may generate a hash of the first asset block 316 (e.g., by applying the hashing function or algorithm to the first asset block) or a portion of the first asset block 316, such as the party identifier 324, and transmit the hash (e.g., hash of the asset block) to the asset repository server 302. In some cases, the asset repository server 302 may store the hash as a part of a hash chain for the asset 304A. Of note, while shown separate from the asset repository server 302, it may be understood that the distribution tool 318 may be included in (e.g., as software executing on) the asset repository server 302.

In some cases, the authenticated party 310 may have a license 308B which allows redistribution and the authenticated party 310 may redistribute the asset 304B to a trusted party 330. To redistribute the asset 304B, the authenticated party 310 may use distribution tool 332. In some cases, distribution tool 332 may be similar to distribution tool 318. The authenticated party 310 may input the first asset block 316 along with identity information (e.g., identifier 340) for the trusted party 330 to the distribution tool 332.

In some cases, the distribution tool 332 may verify the first asset block 316 and generate a second asset block 334. For example, the distribution tool 332 may verify, based on the digital signature 328, that the asset block 316 has not been altered, that the public key 322 is a valid public key associated with an organization that controls the asset repository server 302, and/or that the license 308B allows redistribution of the asset 304B.

After verification, the distribution tool 332 may generate the second asset block 334 for distribution to the trusted party 330. To generate the second asset block 334, the distribution tool 332 may hash 336 the second header 320 (e.g., by applying the hashing function or algorithm to the second header 320) along with the hash 326 of the first header information to generate a third header 338 including the hash 336 of the second header 320 and hash 326 of the first header information. A timestamp (e.g., based on when a request to create the second asset block 334 is made, when the third header 338 was generated, etc.) and/or another nonce number may also be included in the third header 338. An identifier 340 for the trusted party 330 may be obtained by the authenticated party 310 and provided to the distribution tool 332. The distribution tool 332 may include the identifier 340 (or information based on the identifier 340) along with the party identifier 324 identifying the authenticated party 310 in a party identifier 342 of the second asset block 334. In some cases, the distribution tool 332 may modify the asset 304B to generate asset 304C for the second asset block 334. The modifications may include additional hidden and/or invisible watermarks, passwords, and/or encryption. The distribution tool 332 may also modify the license 308B to generate license 308C for the second asset block 334. The license 308C may include the same access restrictions as from license 308B, or the license 308C may include additional access restrictions. These access restrictions may be based on a number of license factors, such as the identity of the trusted party 330, options selected by the authenticated party 310, etc. The distribution tool 332 may also sign the second asset block 334. In some cases, the distribution tool 332 may generate a signature 344 for the second asset block 334 using a private key of the redistributor (e.g., the authenticated party 310). In some cases, the signature 344 may be generated using the private key of the authenticated party 310 and the public key 322 of the original distributor (e.g., asset repository server 302). The signature 344 may also include a hash of the second asset block 334 (e.g., by based on application of the hashing function or algorithm to the second asset block 334).

In some cases, such as where the license 308C allows the trusted party 330 to redistribute the asset 304C, the distribution tool 332 may generate a hash of the second asset block 334 or a portion of the second asset block 334, such as the party identifier 342, and transmit the hash to the asset repository server 302, along with a hash of the first asset block 316, or a portion of the first asset block 316. In some cases, the asset repository server 302 may store the hash as a part of a hash chain for the asset. In cases where the license 308C does not allow for redistribution, the hash of the second asset block 334 or a portion of the second asset block 334 may not be generated and/or sent to the asset repository server 302. In some cases, the trusted party 330 may redistribute the asset 304C in a manner substantially similar to redistribution of the asset 304B by the authenticated party 310 discussed above.

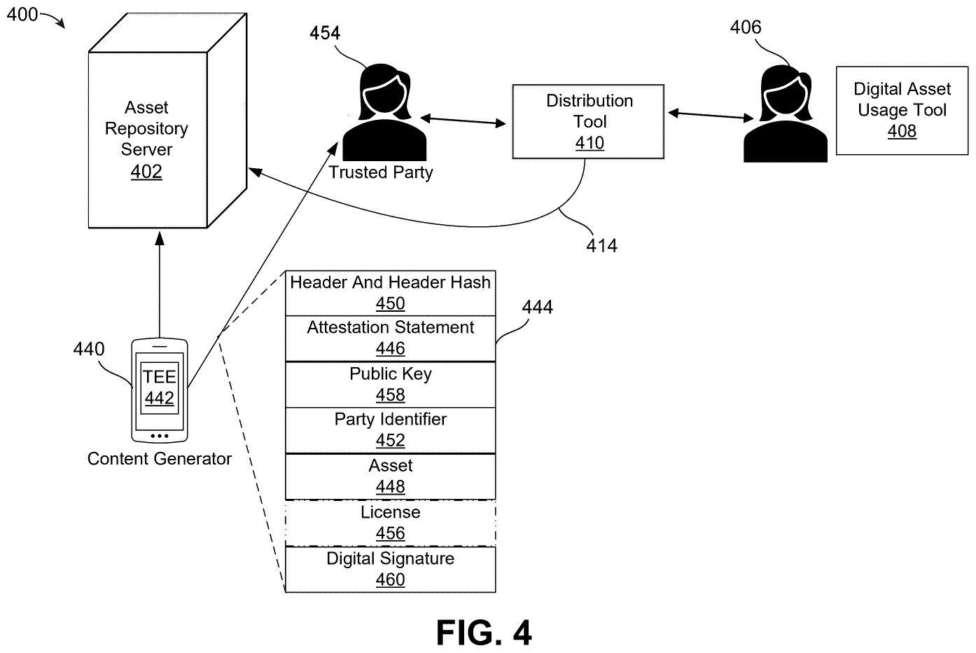

FIG. 4 is a diagram illustrating data transfers for a privacy sensitive, decentralized process for restricted distribution and attribution of data distribution 400, in accordance with aspects of the present disclosure. In some cases, the technique 200 may be adapted to verify that an asset has not been modified beyond a certain way (e.g., generated in part using generative AI algorithms). In FIG. 4, a content generator 440 (e.g., content generation device), such as a smartphone, computer, tablet, etc., may generate an asset. The content generator 440 may include a trusted execution environment (TEE) 442 (e.g., such as an ARM TrustZone execution environment, etc.). The TEE 442 can be used for the safe execution of authorized security software, known as “Trusted Applications”. The TEE 442 may also be able to attest to the integrity of certain software executing on the content generator 440. As used herein attestation is a process by which software executing on a device (e.g., content generator 440) provides an assertion (e.g., information) to a relying party about the integrity of the platform. Examples for the assertion may include a hash of the application, a measurement of an operating system kernel, cryptographic function, security software, etc., or a measurement of another software/hardware of the content generator 440. The assertion, or attestation statement, may help provide assurance to a relying party that the content generator 440 has not been compromised prior to performing certain functionality, such as creating the asset. By attesting that the asset was created using software that does not support generative AI, the TEE 442 may attest that the asset was not created using generative AI. Generative AI may refer to artificial intelligence (e.g., machine learning (ML) models) capable of generating content based on data that the generative AI was trained on.

In some cases, the TEE 442 may generate an asset block 444 including the attestation statement 446 that generative AI (or other generative techniques, editing techniques, etc.) were not used to create the asset 448 of the asset block. In some cases, the TEE 442 may watermark the asset 448. The TEE 442 may also generate a header 450 and hash of the header in a manner similar to how the second header 320 of FIG. 3 is generated. The TEE 442 may also insert a party identifier 452 associated with a first trusted party 454 (e.g., individual, group of individuals, organization, social media site, anyone, etc.) that the asset 448 is being distributed to into the asset block 444. The asset block 444 may also include a license 456, which may be substantially similar to license 308 of FIG. 3. The TEE 442 may also include a public key 458 based on a private key associated with the content generator 440 and sign the asset block 444 using a digital signature 460 based on the private key. The digital signature may include a hash of the asset block 444 to allow for verification of the asset block 444. A hash of the asset block 444, public key 458, and digital signature 460 of the asset block 444 may be sent to the asset repository server 402. The asset repository server 402 may be substantially similar to asset repository server 202 of FIG. 2 and/or asset repository server 302 of FIG. 3.

The asset block 444 from the content generator 440 may be received by (e.g., accessed by) the first trusted party 454 using a digital asset usage tool 408. The digital asset usage tool 408 may be substantially similar to digital asset usage tool 208 of FIG. 2. The digital asset usage tool 408 may check the digital signature 460 to verify that the asset block 444 has not been modified. The digital asset usage tool 408 may also verify the asset block 444 by hashing the asset block 444 and checking with the asset repository server 402 whether there is a record of the hash of the asset block 444 at the asset repository server 402. If there is a record of the hash at the asset repository server 402, the digital asset usage tool 408 may allow access to the asset 448 and/or indicate that the asset 448 is verified (e.g., not substantially modified, not generated/modified by generative AI, etc.).

In some cases, the first trusted party 454 may redistribute the asset block 444 to a second trusted party 406 in a manner substantially similar to redistribution of asset block 316 to the trusted party 330 as discussed above with respect to FIG. 3. In some cases, such as if the party identifier 452 and/or license 456 indicates that the asset block 444 may be freely distributed, the first trusted party 454 may redistribute the asset block 444 to anyone via the distribution tool 410 without modifying the asset block 444. As a part of redistributing the asset block 444, the distribution tool 410 may apply a hashing function to the asset block 444 to obtain a hash of the asset block value and this value may be sent 414 to the asset repository server 402 to help attribute how the asset block 444 was distributed.

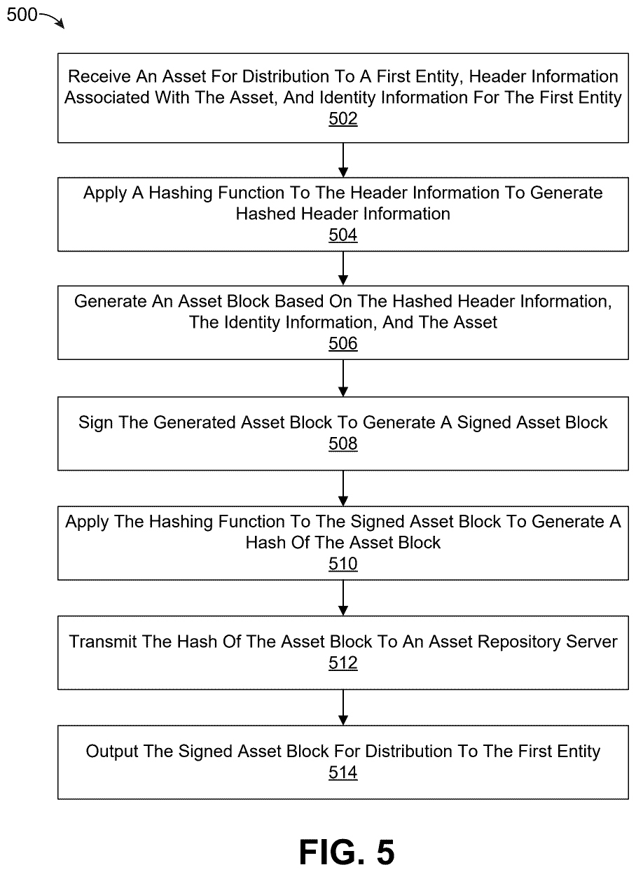

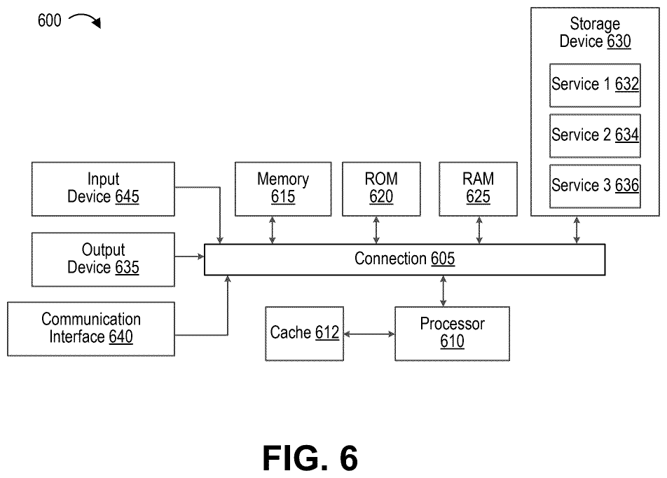

FIG. 5 is a flow diagram illustrating a process 500 for asset distribution, in accordance with aspects of the present disclosure. The process 500 may be performed by a computing device (e.g., apparatus, device of an authenticated party 204 of FIG. 2, authenticated party 310 of FIG. 3, trusted party 454 of FIG. 4, content generator 440 of FIG. 4, etc.) or a component (e.g., a chipset, codec, etc., such as a processor 610 of FIG. 6) of the computing device. The computing device may be a mobile device (e.g., a mobile phone), a network-connected wearable such as a watch, an extended reality (XR) device such as a virtual reality (VR) device or augmented reality (AR) device, a laptop computer, desktop computer, tablet, vehicle or component or system of a vehicle, or other type of computing device. The operations of the process 500 may be implemented as software components that are executed and run on one or more processors (e.g., processor 610 of FIG. 6, and/or other processor(s)). In some cases, the operations of the process 500 can be implemented by a system having the architecture of computing system 600 of FIG. 6.

At block 502, the computing device (or component thereof) may receive an asset (e.g., asset 304A of FIG. 3, asset 448 of FIG. 4, etc.) for distribution (e.g., from a content generator such as content generator 440 of FIG. 4, etc.) to a first entity (e.g., second trusted party 212 of FIG. 2, trusted party 330 of FIG. 3, trusted party 454 of FIG. 4, etc.), header information (e.g., second header 320 of FIG. 3, header 450 of FIG. 4, etc.) associated with the asset, and identity information (e.g., identifier 340 of FIG. 3) for the first entity. In some cases, the asset may be received from an asset repository, such as asset repository server 202 of FIG. 2, asset repository server 302 of FIG. 3, asset repository server 402 of FIG. 4, etc., or a content generator, such as content generator 440 of FIG. 4, etc.

At block 504, the computing device (or component thereof) may apply a hashing function to the header information to generate hashed header information (e.g., hash 336 of FIG. 3, header 450 and hash of FIG. 4, etc.).

At block 506, the computing device (or component thereof) may generate an asset block (e.g., second asset block 334 of FIG. 3, asset block 444 of FIG. 4, etc.) based on the hashed header information, the identity information, and the asset. In some cases, the asset block further includes at least one of: identity information for the asset repository server (e.g., party identifier 324 of FIG. 3); a public key of the asset repository server (e.g., public key 322); a license (e.g., license 308B) including restrictions for the asset; a nonce number; and a timestamp. In some examples, the computing device (or component thereof) may modify the asset by at least one of: adding a watermark; encrypting the asset; and password protecting the asset. In some cases, the computing device (or component thereof) may receive an attestation statement, and wherein the generated asset block further includes the attestation statement. For example, the attestation statement may help provide assurance to a relying party that the computing device (or component thereof) (e.g., content generator 440 of FIG. 4) has not been compromised prior to, while, or since performing certain functionality, such as creating the asset.

At block 508 the computing device (or component thereof) may sign (e.g., digital signature 344 of FIG. 3, digital signature 460 of FIG. 4, etc.) the generated asset block to generate a signed asset block. In some cases, the computing device (or component thereof) may sign the generated asset block by signing the generated asset block based on a private key of the computing device.

At block 510, the computing device (or component thereof) may apply the hashing function to the signed asset block to generate a hash of the asset block. For example, the distribution tool 332 of FIG. 3 may generate a hash of the second asset block 334 of FIG. 3, or a portion of the second asset block 334 of FIG. 3, and transmit the hash to the asset repository server 302 of FIG. 3.

At block 512, the computing device (or component thereof) may transmit the hash of the asset block to an asset repository server. In some cases, the transmitted hash of the asset block may be used to establish an attribution chain indicating how the digital asset was distributed.

At block 514, the computing device (or component thereof) may output the signed asset block for distribution to the first entity. In some cases, the computing device (or component thereof) may receive a second asset block; apply the hashing function to the second asset block to generate a hashed second asset block; and transmit the hashed second asset block to the asset repository server. In some examples, the computing device (or component thereof) may receive, from the asset repository server, an indication that the second asset block is accessible; and verify a signature of the second asset block based on the indication that the second asset block is accessible. In some cases, the computing device (or component thereof) may obtain one or more access restrictions from the second asset block; and limit access to the second asset block based on the one or more access restrictions. For example, access restrictions may be obtained from a license included with the second asset block.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 500 and/or other processes described herein may include a processor, microprocessor, micro-computer, or other component of a device that is configured to carry out the steps of the process 500 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 500 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 500 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 500 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a diagram illustrating an example of a system for implementing certain aspects of the present technology. In particular, FIG. 6 illustrates an example of computing system 600, which can be for example any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 600 includes at least one processing unit (CPU or processor) 610 and connection 605 that couples various system components including system memory 615, such as read-only memory (ROM) 620 and random access memory (RAM) 625 to processor 610. Computing system 600 can include a cache 612 of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, camera, accelerometers, gyroscopes, etc. Computing system 600 can also include output device 635, which can be one or more of a number of output mechanisms. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some examples, a hardware service that performs a particular function can include the software component stored in a computer-readable medium in connection with the necessary hardware components, such as processor 610, connection 605, output device 635, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for digital asset distribution, the apparatus comprising: a memory; and a processor coupled to the memory, the processor being configured to: receive an asset for distribution to a first entity, header information associated with the asset, and identity information for the first entity; apply a hashing function to the header information to generate hashed header information; generate an asset block based on the hashed header information, the identity information, and the asset; sign the generated asset block to generate a signed asset block; apply the hashing function to the signed asset block to generate a hash of the asset block; transmit the hash of the asset block to an asset repository server; and output the signed asset block for distribution to the first entity.

Aspect 2. The apparatus of Aspect 1, wherein the asset block further includes at least one of: identity information for the asset repository server; a public key of the asset repository server; a license including restrictions for the asset; a nonce number; and a timestamp.

Aspect 3. The apparatus of any of Aspects 1-2, wherein, to sign the generated asset block, the processor is configured to sign the generated asset block based on a private key of the apparatus.

Aspect 4. The apparatus of any of Aspects 1-3, wherein the processor is configured to modify the asset by at least one of: adding a watermark; encrypting the asset; and password protecting the asset.

Aspect 5. The apparatus of any of Aspects 1-4, wherein the processor is configured to: receive a second asset block; apply the hashing function to the second asset block to generate a hashed second asset block; and transmit the hashed second asset block to the asset repository server.

Aspect 6. The apparatus of Aspect 5, wherein the processor is further configured to: receive, from the asset repository server, an indication that the second asset block is accessible; and verify a signature of the second asset block based on the indication that the second asset block is accessible.

Aspect 7. The apparatus of any of Aspects 5-6, wherein the processor is configured to: obtain one or more access restrictions from the second asset block; and limit access to the second asset block based on the one or more access restrictions.

Aspect 8. The apparatus of any of Aspects 1-7, wherein the processor is configured to receive an attestation statement, and wherein the generated asset block further includes the attestation statement.

Aspect 9. A method for digital asset distribution, comprising: receiving an asset for distribution to a first entity, header information associated with the asset, and identity information for the first entity; applying a hashing function to the header information to generate hashed header information; generating an asset block based on the hashed header information, the identity information, and the asset; signing the generated asset block to generate a signed asset block; applying the hashing function to the signed asset block to generate a hash of the asset block; transmitting the hash of the asset block to an asset repository server; and outputting the signed asset block for distribution to the first entity.

Aspect 10. The method of Aspect 9, wherein the asset block further includes at least one of: identity information for the asset repository server; a public key of the asset repository server; a license including restrictions for the asset; a nonce number; and a timestamp.

Aspect 11. The method of any of Aspects 9-10, wherein signing the generated asset block comprises signing the generated asset block based on a private key.

Aspect 12. The method of any of Aspects 9-11, further comprising modifying the asset by at least one of: adding a watermark; encrypting the asset; and password protecting the asset.

Aspect 13. The method of any of Aspects 9-12, further comprising: receiving a second asset block; applying the hashing function to the second asset block to generate a hashed second asset block; and transmitting the hashed second asset block to the asset repository server.

Aspect 14. The method of Aspect 13, further comprising: receiving, from the asset repository server, an indication that the second asset block is accessible; and verifying a signature of the second asset block based on the indication that the second asset block is accessible.

Aspect 15. The method of any of Aspects 13-14, further comprising: obtaining one or more access restrictions from the second asset block; and limiting access to the second asset block based on the one or more access restrictions.

Aspect 16. The method of any of Aspects 9-15, further comprising receiving an attestation statement, wherein the generated asset block further includes the attestation statement.

Aspect 17. A non-transitory computer-readable medium having stored thereon instructions that, when executed by at least one processor, cause the at least one processor to: receive an asset for distribution to a first entity, header information associated with the asset, and identity information for the first entity; apply a hashing function to the header information to generate hashed header information; generate an asset block based on the hashed header information, the identity information, and the asset; sign the generated asset block to generate a signed asset block; apply the hashing function to the signed asset block to generate a hash of the asset block; transmit the hash of the asset block to an asset repository server; and output the signed asset block for distribution to the first entity.

Aspect 18. The non-transitory computer-readable medium of Aspect 17, wherein the asset block further includes at least one of: identity information for the asset repository server; a public key of the asset repository server; a license including restrictions for the asset; a nonce number; and a timestamp.

Aspect 19. The non-transitory computer-readable medium of any of Aspects 17-18, wherein, to sign the generated asset block, the instructions cause the processor to sign the generated asset block based on a private key.

Aspect 20. The non-transitory computer-readable medium of any of Aspects 17-19, wherein the instructions cause the processor to modify the asset by at least one of: adding a watermark; encrypting the asset; and password protecting the asset.

Aspect 21. A non-transitory computer-readable medium having stored thereon instructions that, when executed by at least one processor, cause the at least one processor to performing one or more of operations according to any of Aspects 9 to 16

Aspect 22: An apparatus for digital asset distribution, comprising means for performing one or more of operations according to any of Aspects 9 to 16.

What is claimed is:

1. An apparatus for digital asset distribution, the apparatus comprising:
a memory; and
a processor coupled to the memory, the processor being configured to:
receive an asset for distribution to a first entity, header information associated with the asset, and identity information for the first entity;
apply a hashing function to the header information to generate hashed header information;
generate an asset block based on the hashed header information, the identity information, and the asset;
sign the generated asset block to generate a signed asset block;
apply the hashing function to the signed asset block to generate a hash of the asset block;
transmit the hash of the asset block to an asset repository server; and
output the signed asset block for distribution to the first entity.

2. The apparatus of claim 1, wherein the asset block further includes at least one of:
identity information for the asset repository server;
a public key of the asset repository server;
a license including restrictions for the asset;
a nonce number; and
a timestamp.

3. The apparatus of claim 1, wherein, to sign the generated asset block, the processor is configured to sign the generated asset block based on a private key of the apparatus.

4. The apparatus of claim 1, wherein the processor is configured to modify the asset by at least one of:
adding a watermark;
encrypting the asset; and
password protecting the asset.

5. The apparatus of claim 1, wherein the processor is configured to:
receive a second asset block;
apply the hashing function to the second asset block to generate a hashed second asset block; and
transmit the hashed second asset block to the asset repository server.

6. The apparatus of claim 5, wherein the processor is further configured to:
receive, from the asset repository server, an indication that the second asset block is accessible; and
verify a signature of the second asset block based on the indication that the second asset block is accessible.

7. The apparatus of claim 5, wherein the processor is configured to:
obtain one or more access restrictions from the second asset block; and
limit access to the second asset block based on the one or more access restrictions.

8. The apparatus of claim 1, wherein the processor is configured to receive an attestation statement, and wherein the generated asset block further includes the attestation statement.

9. A method for digital asset distribution, comprising:
receiving an asset for distribution to a first entity, header information associated with the asset, and identity information for the first entity;
applying a hashing function to the header information to generate hashed header information;
generating an asset block based on the hashed header information, the identity information, and the asset;
signing the generated asset block to generate a signed asset block;
applying the hashing function to the signed asset block to generate a hash of the asset block;
transmitting the hash of the asset block to an asset repository server; and
outputting the signed asset block for distribution to the first entity.

10. The method of claim 9, wherein the asset block further includes at least one of:
identity information for the asset repository server;
a public key of the asset repository server;
a license including restrictions for the asset;
a nonce number; and
a timestamp.

11. The method of claim 9, wherein signing the generated asset block comprises signing the generated asset block based on a private key.

12. The method of claim 9, further comprising modifying the asset by at least one of:
adding a watermark;
encrypting the asset; and
password protecting the asset.

13. The method of claim 9, further comprising:
receiving a second asset block;
applying the hashing function to the second asset block to generate a hashed second asset block; and
transmitting the hashed second asset block to the asset repository server.

14. The method of claim 13, further comprising:
receiving, from the asset repository server, an indication that the second asset block is accessible; and
verifying a signature of the second asset block based on the indication that the second asset block is accessible.

15. The method of claim 13, further comprising:
obtaining one or more access restrictions from the second asset block; and
limiting access to the second asset block based on the one or more access restrictions.

16. The method of claim 9, further comprising receiving an attestation statement, wherein the generated asset block further includes the attestation statement.

17. A non-transitory computer-readable medium having stored thereon instructions that, when executed by at least one processor, cause the at least one processor to:
receive an asset for distribution to a first entity, header information associated with the asset, and identity information for the first entity;
apply a hashing function to the header information to generate hashed header information;
generate an asset block based on the hashed header information, the identity information, and the asset;
sign the generated asset block to generate a signed asset block;
apply the hashing function to the signed asset block to generate a hash of the asset block;
transmit the hash of the asset block to an asset repository server; and
output the signed asset block for distribution to the first entity.

18. The non-transitory computer-readable medium of claim 17, wherein the asset block further includes at least one of:
identity information for the asset repository server;
a public key of the asset repository server;
a license including restrictions for the asset;
a nonce number; and
a timestamp.

19. The non-transitory computer-readable medium of claim 17, wherein, to sign the generated asset block, the instructions cause the processor to sign the generated asset block based on a private key.

20. The non-transitory computer-readable medium of claim 17, wherein the instructions cause the processor to modify the asset by at least one of:
adding a watermark;
encrypting the asset; and
password protecting the asset.
